(19) United States
(12) Patent Application Publication
(10) Pub. No.: US 2008/0052360 A1
(43) Pub. Date: Feb. 28, 2008

(54) Rules Profiler

(75) Inventor: Amit Jhawar, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/466,405

(22) Filed: Aug. 22, 2006

(51) Int. Cl. G06F 15/16; G06F 15/173

(52) U.S. Cl. 709/206; 709/223

(57) ABSTRACT

A set of filter rules are applied to pieces of text. The runtime for each rule of the set of filter rules is determined. The runtime performance of the set of filter rules based on the runtime for each rule is outputted.

### BACKGROUND

Filters are often used to scan text to determine if the text includes undesired material. For example, virus filters may be used to scan for malicious code in downloaded files. In another example, email systems may use spam filters to scan for spam messages. Currently, there is a lack of tools for testing such filters.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Embodiments of the invention include a rules profiler to test the runtime performance of rules for use in a filter. In one instance, runtime performances may be recorded and analyzed in a quality assurance environment before the rules are used in a deployed environment, such as in a spam filter. Embodiments of the rules profiler may collect other statistical data in connection with runtimes of the rules.

Many of the attendant features will be more readily appreciated as the same becomes better understood by reference to the following detailed description considered in connection with the accompanying drawings.

### BRIEF DESCRIPTION OF THE DRAWINGS

Like reference numerals are used to designate like parts in the accompanying drawings.

FIG. 1 is a block diagram of an example operating environment to implement embodiments of the invention.

FIG. 2 is a block diagram of an example operating environment to implement embodiments of the invention.

FIG. 3 is a flowchart showing the logic and operations of spam filter having a rules profiler in accordance with an embodiment of the invention.

FIG. 4 is a block diagram of a spam filter having a rules profiler in accordance with an embodiment of the invention.

### DETAILED DESCRIPTION

The detailed description provided below in connection with the appended drawings is intended as a description of the present examples and is not intended to represent the only forms in which the present examples may be constructed or utilized. The description sets forth the functions of the examples and the sequence of steps for constructing and operating the examples. However, the same or equivalent functions and sequences may be accomplished by different examples.

Embodiments of the invention may be applied to any rules-based filter. A filter may be used to search through text to discover unwanted material. Embodiments of the invention may be used to determine runtimes of rules in a spam filter, a virus filter, and the like. The text for filtering may include a message (described further below). The text for filtering may also include files, code, such as Hypertext Markup Language (HTML), and the like. For example, a file downloaded by a user may be scanned by a virus filter. Rules in the virus filter may be tested using embodiments described herein.

A message may include one or more blocks of text as well as beginning and ending characters, header information, and/or error-checking information. Example messages include email messages, instant messages, mobile device text messages, and the like. While embodiments of the invention are described in relation to email messages, one skilled in the art having the benefit of this description will appreciate that embodiments of the invention may be used with other types of messages.

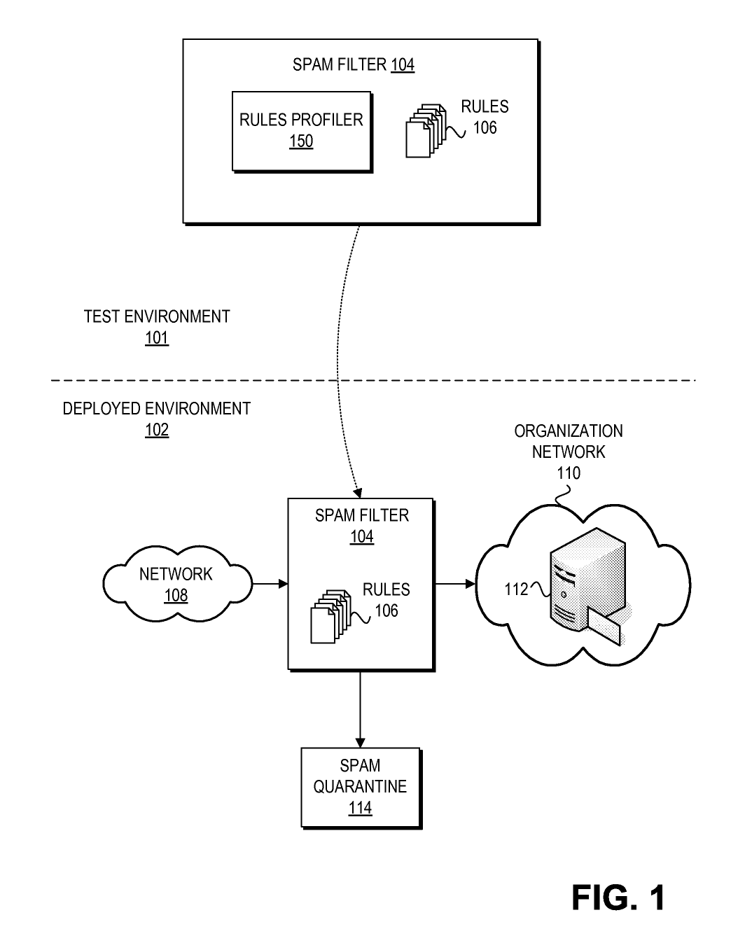

Turning to FIG. 1, an example operating environment to implement embodiments of the invention is shown. While FIG. 1 shows a spam filter environment, it will be appreciated that embodiments of the invention may be applied to other filtering settings. FIG. 1 shows a test environment 101 and a deployed environment 102. In test environment 101, a spam filter 104 includes a rules profiler 150 and rules 106. Rules profiler 150 may be used to test each rule's runtime performance. Analysis of the rules' runtime performances allows testers to discover rules that may exceed a desired runtime threshold, such as a maximum average runtime. In this way, rules 106 may be tested prior to deployment. Rules with an excessive runtime may be removed or rewritten to execute more efficiently.

After rules 106 have been tested, rules 106 may be used in deployed environment 102. In one embodiment, deployed spam filter 104 does not include rules profiler 150. Deployed spam filter 104 may be compiled and deployed without rules profiler 150 in order to remove execution overhead associated with rules profiler 150. Alternatively, spam filter 104 may be deployed with rules profiler 150.

In deployed environment 102, spam filter 104 receives email message traffic from a network 108, such as the Internet, that is destined for an organization's network 110. Organization network 110 may include one or more email servers 112. Spam filter 104 identifies email messages that are spam using rules 106. In one embodiment, email messages determined to be spam are not forwarded to network 110, but are sent to a spam quarantine area 114. While deployed environment 102 shows a single spam filter 104, it will be appreciated that two or more spam filters 104 may work in conjunction to protect network 110.

Spam filter 104 may be used by in-house department or may be part of hosted service provider. An in-house information technology department of an organization may maintain the organization's spam filtering. Alternatively, a hosted service provider may include a service company that provides spam filtering for an organization's network.

Rules 106 may define characteristics of spam and/or of legitimate messages. In one embodiment, a score is assigned to each incoming email message. Points are added to the score if the email message contains characteristics of spam and points are subtracted if the email message contains characteristics of legitimate messaging. When a message reaches a threshold score, the email message is marked as spam. In one embodiment, rules 106 may include approximately 10,000 to 20,000 rules.

In one embodiment, a rule may include a regular expression. In general, a regular expression includes a pattern that describes text. For example, the regular expression “we.” would match “wet”, “web”, etc., where the dot (“.”) represents any single character.

In one embodiment, rules 106 may include any combination of the following types of rules, although other types of rules may be considered as appropriate. From rules are applied to ‘mail from’ and the ‘from’ header in an email message. To rules are applied to ‘rcpt to’ and the ‘to’ header. Subject rules are applied to the subject header. Body rules are applied to the text parts of the email message. HTML (Hypertext Markup Language) rules are applied to HTML parts of the email message. Each rule may have a rule identification (ID), such as a numeric ID. In one embodiment, the rule type and rule ID form a primary key for reference to any rule in the spam filter.

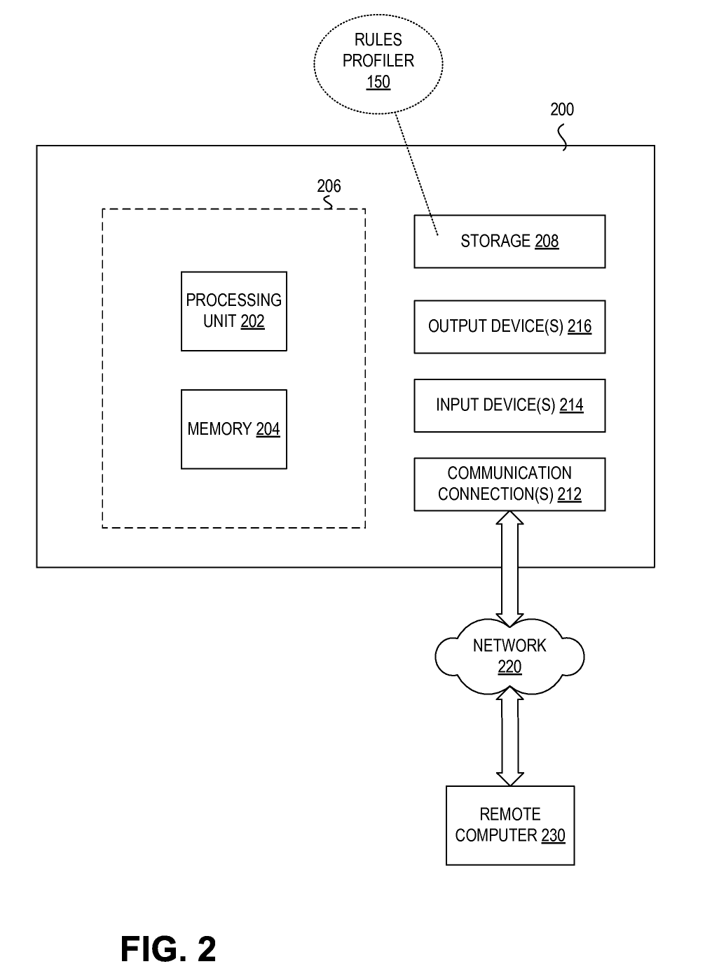

FIG. 2 and the following discussion provide a brief, general description of a suitable computing environment to implement embodiments of the invention. The operating environment of FIG. 2 is only one example of a suitable operating environment and is not intended to suggest any limitation as to the scope of use or functionality of the operating environment. Other well known computing systems, environments, and/or configurations that may be suitable for use with embodiments described herein including, but not limited to, personal computers, server computers, hand-held or laptop devices, multiprocessor systems, micro-processor based systems, programmable consumer electronics, network personal computers, mini computers, mainframe computers, distributed computing environments that include any of the above systems or devices, and the like.

Although not required, embodiments of the invention will be described in the general context of “computer readable instructions” being executed by one or more computers or other computing devices. Computer readable instructions may be distributed via computer readable media (discussed below). Computer readable instructions may be implemented as program modules, such as functions, objects, application programming interfaces (APIs), data structures, and the like, that perform particular tasks or implement particular abstract data types. Typically, the functionality of the computer readable instructions may be combined or distributed as desired in various environments.

FIG. 2 shows an exemplary system for implementing one or more embodiments of the invention in a computing device 200. In its most basic configuration, computing device 200 typically includes at least one processing unit 202 and memory 204. Depending on the exact configuration and type of computing device, memory 204 may be volatile (such as RAM), non-volatile (such as ROM, flash memory, etc.) or some combination of the two. This most basic configuration is illustrated in FIG. 2 by dashed line 206.

Additionally, device 200 may also have additional features and/or functionality. For example, device 200 may also include additional storage (e.g., removable and/or non-removable) including, but not limited to, magnetic or optical disks or tape. Such additional storage is illustrated in FIG. 2 by storage 208. In one embodiment, computer readable instructions to implement embodiments of the invention may be stored in storage 208, shown as rules profiler 150. Storage 208 may also store other computer readable instructions to implement an operating system, an application program, and the like.

The term “computer readable media” as used herein includes computer storage media. Computer storage media includes volatile and nonvolatile, removable and non-removable media implemented in any method or technology for storage of information such as computer readable instructions, data structures, program modules, or other data. Memory 204 and storage 208 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which can be used to store the desired information and which can be accessed by device 200. Any such computer storage media may be part of device 200.

Device 200 may also include communication connection(s) 212 that allow the device 200 to communicate with other devices, such as with other computing devices through network 220. Communications connection(s) 212 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media.

Device 200 may also have input device(s) 214 such as keyboard, mouse, pen, voice input device, touch input device, laser range finder, infra-red cameras, video input devices, and/or any other input device. Output device(s) 216 such as one or more displays, speakers, printers, and/or any other output device may also be included.

Those skilled in the art will realize that storage devices utilized to store computer readable instructions may be distributed across a network. For example, a remote computer 230 accessible via network 220 may store computer readable instructions to implement one or more embodiments of the invention. Computing device 200 may access remote computer 230 and download a part or all of the computer readable instructions for execution. Alternatively, computing device 200 may download pieces of the computer readable instructions, as needed, or some instructions may be executed at computing device 200 and some at remote computer 230. Those skilled in the art will also realize that all or a portion of the computer readable instructions may be carried out by a dedicated circuit, such as a Digital Signal Processor (DSP), programmable logic array, and the like.

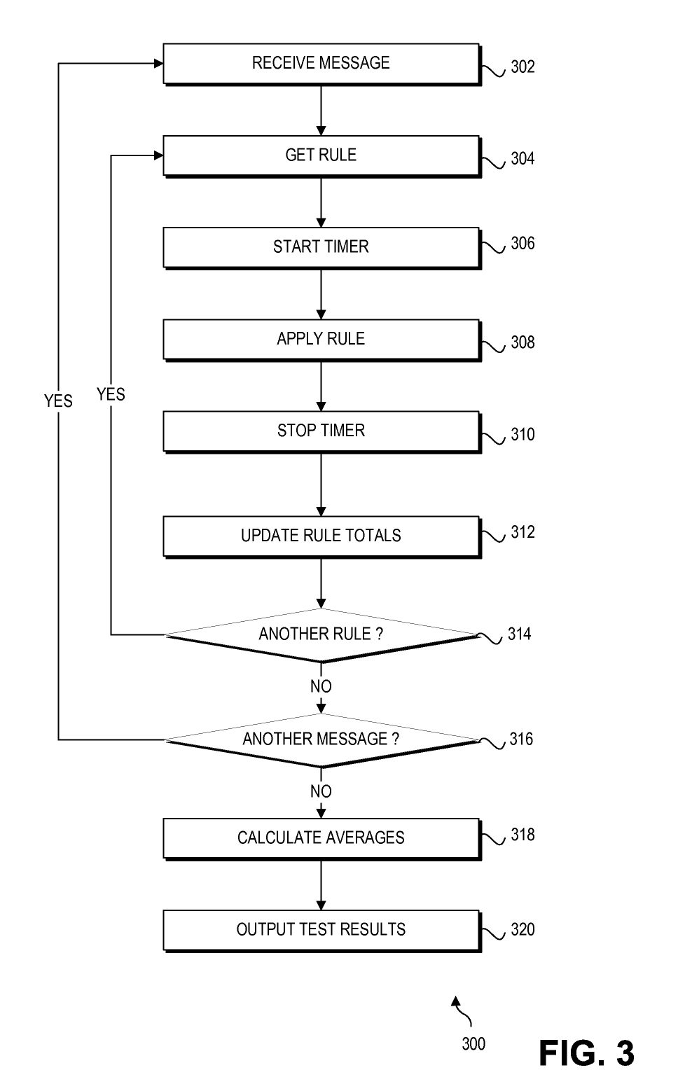

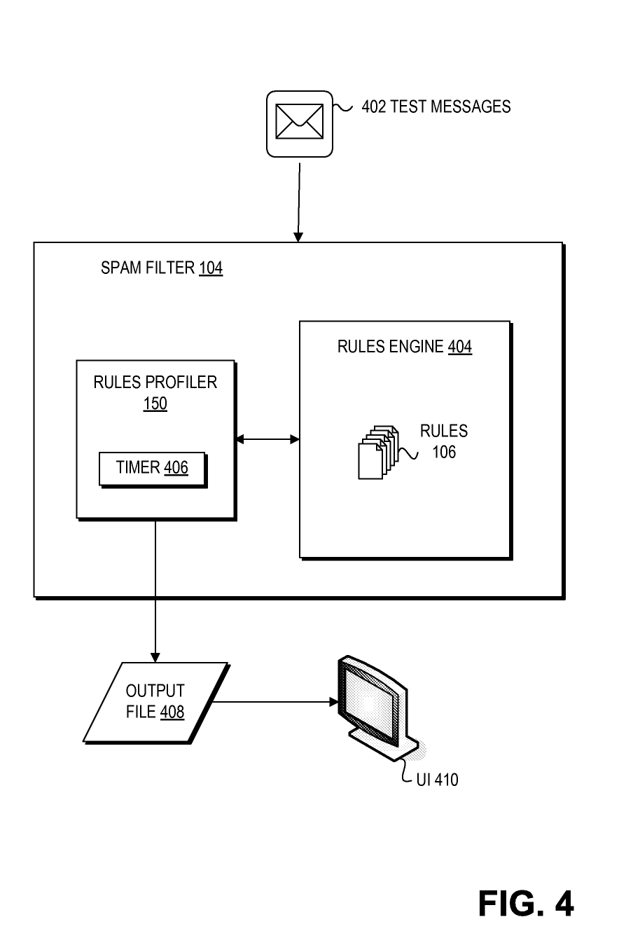

Turning to FIG. 3, a flowchart 300 shows the logic and operations of a spam filter having a rules profiler in accordance with an embodiment of the invention. The discussion of flowchart 300 references FIG. 4 which shows an embodiment of spam filter 104.

Starting in block 302, a message is received at the spam filter. In FIG. 4, an email message from test messages 402 is inserted into spam filter 104. In one embodiment, approximately 10,000 spam messages are used for testing. Test messages 402 may include known spam from real world message traffic. In another embodiment, a filter may be tested with other types of messages; in yet another embodiment, rules may be tested with other pieces of text other than messages, such as a file in the context of a virus filter.

In one embodiment, test messages 402 may be kept constant to give a baseline for comparison of runtime performance of rules in future iterations. Test messages 402 may have a wide variety in terms of structure and complexity in order to thoroughly test rules 106.

Continuing to block 304, a rule is obtained from rules 106. Next, the runtime for applying the rule to the message is determined. One embodiment of determining the runtime is described in conjunction with blocks 306, 308, and 310. In block 306, a timer 406 is started. In block 308, the rule is applied to the message. When the rule has finished executing, timer 406 is stopped, as shown in block 310.

Continuing to block 312, totals for the rule are updated. The totals may include the total number of times the rule is applied, the total number of bytes scanned by the rule, and the total runtime for the rule. It will be appreciated that every rule may not be applied to every message. For example, an HTML rule type may not be applied to an email message that does not include HTML.

Proceeding to decision block 314, the logic determines if there is another rule for execution. If the answer to decision block 314 is yes, then the logic returns to block 304. If the answer to decision block 314 is no, then the logic proceeds to decision block 316 to determine if there is another message to process. If the answer is yes, then the logic returns to block 302. If the answer is no, then the logic continues to block 318.

At block 318, the logic calculates averages for each rule based on the recorded totals data. In one embodiment, an average runtime per message is calculated for each rule. Average runtime per message may be calculated by dividing the total runtime for a rule by the number of times the rule was applied.

In another embodiment, an average runtime each rule took to scan a byte is calculated. Average runtime per byte may be calculated by dividing the total runtime for a rule by the total number of bytes scanned by the rule. It will be appreciated that the average runtime per byte provides efficiency information regardless of the message type and regardless of the message size.

Continuing to block 320, the test results are outputted. In FIG. 4, rules profiler 150 outputs an output file 408. Output file 408 may be used with a user interface (UI) 410 to provide information in a convenient form for searching, sorting, and analyzing. UI 410 may also provide additional information such as histograms, other averages, medians, and standard deviations for each rule or rule type.

Output file 408 comprises a message type identifier and/or rule identification associated with one or more results data. The output file may be any kind of data store, including a relational database, object-oriented database, unstructured database, an in-memory database, or other data store. An output file may be constructed using a flat file system such as ASCII text, a binary file, data transmitted across a communication network, or any other file system. Notwithstanding these possible implementations of the foregoing output file, the term file as used herein refers to any data that is collected and stored in any manner accessible by a computing device.

In one embodiment, output file 408 may have the following file format. A row for each rule may include: <rule type><rule id><total number of bytes scanned><number of times rule invoked><total runtime><average runtime per message><average runtime per byte scanned>. Specifically, a rule type identifier may be associated with a rule identifier, or any other primary key reference to a rule. The primary key to a rule may be associated with any combination of results data, which may include a total number of bytes scanned, a number of times a rule is invoked, a total runtime, an average runtime per message, an average runtime per byte scanned, and the like. It should be appreciated that other file formats or combinations of rule type indication and results data may be used as appropriate.

Embodiments of the invention provide a rules profiler for testing the runtime performance of a set of rules. The rules profiler may be used in a test environment before a set of rules is deployed. Successive runs of the rules profiler provide data for predicting the runtime performance of the rules. Additionally, the rules profiler may be used to establish policies as to acceptable runtime performances of rules. For example, a policy may establish that all rules must have an average runtime less than 0.6 microseconds before being allowed to deploy. Rules that are time expensive may be blocked from deployment, rewritten for better performance, or allowed to deploy under a special exception.

It will be appreciated that the rules performance data collected by the rules profiler provides reliable data comparable to real world performance. For example, rules engine 404 is not modified when in a test environment and is the same rules engine used in the deployed spam filter. Thus, the rules may be tested and modified as desired with confidence of similar performance in a deployed spam filter.

Further, data from the rules profiler may be used to develop policies for writing time efficient rules. For example, a rule may test for particular domain names in email messages that indicate spam. New domain names may be added to the rule using an OR statement. However, by using the rules profiler, it was discovered that runtime performance of the rule degrades precipitately if more than 7 domain names are combined with OR statements. Thus, a policy may be instituted limiting the number of terms that may be combined with OR statements.

Various operations of embodiments of the present invention are described herein. In one embodiment, one or more of the operations described may constitute computer readable instructions stored on computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment of the invention.

The above description of embodiments of the invention, including what is described in the Abstract, is not intended to be exhaustive or to limit the embodiments to the precise forms disclosed. While specific embodiments and examples of the invention are described herein for illustrative purposes, various equivalent modifications are possible, as those skilled in the relevant art will recognize in light of the above detailed description. The terms used in the following claims should not be construed to limit the invention to the specific embodiments disclosed in the specification. Rather, the following claims are to be construed in accordance with established doctrines of claim interpretation.

What is claimed is:

1. A method, comprising:
applying a set of filter rules to pieces of text;
determining a runtime for each rule of the set of filter rules; and
outputting runtime performance of the set of filter rules based on the runtime for each rule.

2. The method of claim 1, further comprising determining a total number of bytes scanned by each filter rule.

3. The method of claim 1, further comprising determining a total number of times each filter rule is applied to the pieces of text.

4. The method of claim 1, further comprising calculating the average runtime per piece of text for each filter rule.

5. The method of claim 1, further comprising calculating the average runtime per byte scanned for each filter rule.

6. The method of claim 1 wherein outputting the runtime performance includes outputting a test results file having fields including a key reference associated with at least one member of a group comprising number of bytes scanned, number of times rule applied, total runtime, average runtime per piece of text, and average runtime per byte scanned.

7. The method of claim 1 wherein the set of filter rules include regular expressions.

8. The method of claim 1, further comprising changing a filter rule of the set of filter rules in response to the outputted runtime performance of the set of filter rules.

9. One or more computer readable media including computer readable instructions that, when executed, perform operations comprising:
receiving test messages at a spam filter, wherein the spam filter includes spam filter rules and a rules profiler;
applying the spam filter rules to each of the test messages; and
determining a total runtime for each spam filter rule.

10. The one or more computer readable media of claim 9 wherein the computer readable instructions, when executed, further perform operations comprising:
determining a total number of bytes scanned by each spam filter rule.

11. The one or more computer readable media of claim 9 wherein the computer readable instructions, when executed, further perform operations comprising:
determining a total number of times each spam filter rule is applied.

12. The one or more computer readable media of claim 9 wherein the computer readable instructions, when executed, further perform operations comprising:
calculating an average runtime per test message for each spam filter rule.

13. The one or more computer readable media of claim 9 wherein the computer readable instructions, when executed, further perform operations comprising:
calculating an average runtime per byte scanned for each spam filter rule.

14. The one or more computer readable media of claim 9 wherein the computer readable instructions, when executed, further perform operations comprising:
outputting runtime performance for each spam filter rule based on the total runtime for each spam filter rule.

15. A spam filter, comprising:
a rules engine having rules for detecting spam; and
a rules profiler coupled to the rules engine to determine a runtime performance for each rule applied to a plurality of messages.

16. The spam filter of claim 15 wherein the rules profiler to measure a total number of bytes scanned by each rule.

17. The spam filter of claim 15 wherein the rules profiler to measure a total number of times a rule is applied.

18. The spam filter of claim 15 wherein the rules profiler calculates an average runtime per rule for each rule.

19. The spam filter of claim 15 wherein the rules profiler calculates an average runtime per byte scanned for each rule.

20. The spam filter of claim 15 wherein the rules profiler to output the total runtime in a file for use by a user interface.
